(19) United States
(12) Patent Application Publication
(10) Pub. No.: US 2020/0320887 A1
(43) Pub. Date: Oct. 8, 2020

(54) SYSTEMS AND METHODS FOR PROBABILISTICALLY DETERMINING THE INTENDED FLIGHT ROUTE OF AN AIRCRAFT

(71) Applicant: HONEYWELL INTERNATIONAL INC., Morris Plains, NJ (US)

(72) Inventors: Yu Duan, Beijing (CN); Lu Cheng, Shanghai (CN); Nan Zhang, Beijing (CN)

(73) Assignee: HONEYWELL INTERNATIONAL INC., Morris Plains, NJ (US)

(21) Appl. No.: 16/373,160

(22) Filed: Apr. 2, 2019

(51) Int. Cl. G08G 5/00; G08G 5/04

(52) U.S. Cl. CPC G08G 5/0078; G08G 5/04; G08G 5/0008

(57) ABSTRACT

A method executable by an ownship aircraft for probabilistically determining an intended flight route of an other aircraft in the vicinity of the ownship aircraft includes receiving first positional information regarding the other aircraft at a first point in time, receiving second positional information regarding the other aircraft at a second point in time that is temporally subsequent to the first point in time, and determining a historical flight path of the other aircraft based on the first and second positional information. Furthermore, the method includes comparing the historical flight path of the other aircraft to a plurality of navigation routes and, based on the comparing, probabilistically determining one navigation route of the plurality of navigation routes as the intended flight route of the other aircraft.

### TECHNICAL FIELD

The present disclosure generally relates to aircraft display and air traffic conflict awareness systems and methods. More particularly, the present disclosure relates to systems and methods for probabilistically determining the intended flight route of an aircraft.

### BACKGROUND

It is generally of interest to the flight crew of an aircraft (“ownship”) to have situational awareness of other (e.g., “intruder”) aircraft in the vicinity of the ownship. This situational awareness includes not only the bearing, distance, and vertical separation of the other aircraft with reference to the ownship, but also the intended flight route of the other aircraft. The flight crew of the ownship may use this information to determine whether a traffic conflict exists or is likely to exist between the ownship and the other aircraft, and, if so, to take corrective action accordingly.

While radar-based air traffic control services have historically been used by the flight crew to obtain the aforementioned situational awareness, there are many flight scenarios where radar-based air traffic control services are unavailable. These include, for example, departures from or approaches to airports outside of radar coverage, oceanic airspace, and flights over countries/regions that have limited or unreliable radar services. Moreover, it is expected that future air traffic management programs will rely more heavily on the concept of “free flight,” where the ownship flight crew is able to select their own preferred routing, but accepts responsibility for maintaining adequate separation from other aircraft.

To allow for situational awareness of other aircraft in the aforementioned, non-radar scenarios, on-board systems have been developed that allow an aircraft to independently report its position to other aircraft in its vicinity, and, in turn, to receive such reports from other aircraft. With respect to the ownship, the other aircraft are displayed as symbols on one of the various flight-deck displays. One such system is automatic dependent surveillance-broadcast (“ADS-B”), which consists of two different (but related) services: ADS-B “Out” and ADS-B “In.” Using ADS-B Out, each aircraft periodically broadcasts information about itself, including identification, current position, altitude, and velocity, through an onboard transmitter. ADS-B Out provides air traffic controllers and other aircraft in the vicinity with real-time position information of the ownship that is, in most cases, more accurate than the information derived from current radar-based systems. ADS-B In is the reception of this real-time position information from other aircraft in the vicinity of the ownship and the display thereof to the flight crew.

While the real-time position, altitude, and velocity of other aircraft provided by ADS-B is undoubtably useful to the ownship flight crew in determining whether a traffic conflict exists or is likely to exist, it should be appreciated that aircraft do not fly exclusively in straight lines. Rather, a typical flight route consists of a series of connected segments, where each such segment may require the aircraft to fly a different heading or maintain a different altitude. As such, an aircraft that at one particular point in time appears to the flight crew of the ownship aircraft to be diverging away from the ownship may at a later point in time conduct a turn or otherwise maneuver in accordance with its intended flight route so as to present a conflict. Such intended flight route information is not currently broadcast by aircraft using ADS-B Out or any other system.

As such, it would be desirable to provide the ownship flight crew with improved situational awareness of other aircraft in the vicinity of the ownship. This improved situational awareness would desirably include an independent, probabilistic determination of the intended flight route of the other aircraft such that the flight crew may anticipate future traffic conflicts that would not be immediately apparent from the real-time position, altitude, and velocity information received via ADS-B In. The intended flight route of the other aircraft would also desirably be displayed to the flight crew as an additional feature of a moving map flight-deck display, for example. Furthermore, other desirable features and characteristics of the disclosure will become apparent from the subsequent detailed description and the appended claims, taken in conjunction with the accompanying drawings, brief summary, technical field, and this background of the disclosure.

### BRIEF SUMMARY

Generally disclosed herein are systems and methods for probabilistically determining the intended flight route of an aircraft. In accordance with one exemplary embodiment, a method executable by an ownship aircraft for probabilistically determining an intended flight route of an other aircraft in the vicinity of the ownship aircraft includes receiving first positional information regarding the other aircraft at a first point in time, receiving second positional information regarding the other aircraft at a second point in time that is temporally subsequent to the first point in time, and determining a historical flight path of the other aircraft based on the first and second positional information. Furthermore, the method includes comparing the historical flight path of the other aircraft to a plurality of navigation routes and, based on the comparing, probabilistically determining one navigation route of the plurality of navigation routes as the intended flight route of the other aircraft.

In accordance with another exemplary embodiment, a system executable at an ownship aircraft for probabilistically determining an intended flight route of an other aircraft in the vicinity of the ownship aircraft includes an air traffic surveillance system that (1) receives first positional information regarding the other aircraft at a first point in time and (2) receives second positional information regarding the other aircraft at a second point in time that is temporally subsequent to the first point in time. The system further includes a processing system that (3) determines a historical flight path of the other aircraft based on the first and second positional information, (4) compares the historical flight path of the other aircraft to a plurality of navigation routes, and (5) based on the comparing, probabilistically determines one navigation route of the plurality of navigation routes as the intended flight route of the other aircraft.

This brief summary is provided to describe select concepts in a simplified form that are further described in the detailed description, in accordance with various embodiments that encompass the concepts described in the brief summary. This brief summary is not intended to identify key or essential features of the subject matter of the present disclosure, with reference to the claims or otherwise, nor is this brief summary intended to be used as an aid in determining the full scope of the disclosed subject matter, which is properly determined with reference to the various embodiments of the present disclosure.

### BRIEF DESCRIPTION OF THE DRAWING FIGURES

A more complete understanding of the disclosure may be derived from the accompanying drawing figures, wherein like reference numerals denote like elements, and wherein:

FIG. 1 shows a functional block diagram of an aircraft including various systems and databases in accordance with various embodiments of the present disclosure;

FIG. 2 is a flowchart illustrating a method for probabilistically determining the intended flight route of another aircraft in the vicinity of the aircraft illustrated in FIG. 1 in accordance with various embodiments of the present disclosure; and

FIGS. 3-6 are non-limiting examples of graphical flight-deck displays that illustrate probabilistic intended flight routes of other aircraft in accordance with various embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any flight display system or method embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

Generally disclosed herein are systems and methods for probabilistically determining the intended flight route of an aircraft in the vicinity of the ownship for purposes of providing the ownship flight crew with improved situational awareness regarding potential traffic conflicts. The ownship includes an ADS-B In system as well as a navigation database that includes navigational waypoints, airways, and procedures. The systems and methods of the present disclosure utilize historical and real-time position, altitude, and velocity information pertaining to the other aircraft as received by the ADS-B In system in conjunction with the waypoints, airways, and procedures from the navigational database to probabilistically determine the intended flight route of the other aircraft. This intended flight route is accessible to the ownship flight crew by selecting an appropriate functionality of a flight-deck display.

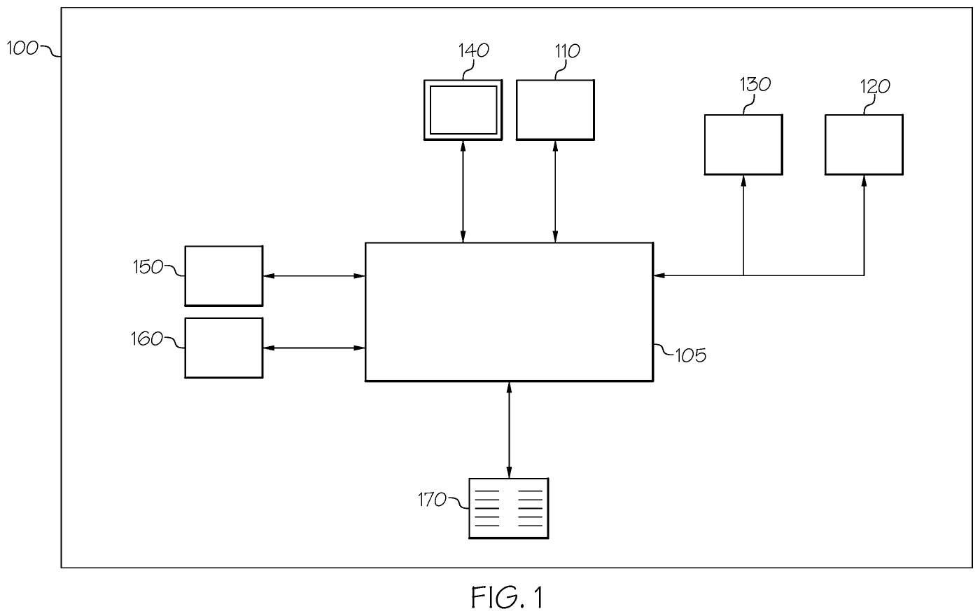

In accordance with one embodiment of the present disclosure, FIG. 1 illustrates an aircraft 100 that includes a processing system 105, a flight management system (FMS) 110, a position-determining system 120, an ADS-B system 130, a flight-deck display system 140, a datalink system 150, a weather radar system 160, and a navigational database 170. It should be appreciated that aircraft 100 includes many more additional features (systems, databases, etc.) than the illustrated systems 105-160 and database 170. For purposes of simplicity of illustration and discussion, however, the illustrated aircraft 100 omits these additional features.

Aircraft 100 may be any type of vehicle that is capable of travelling through the air (i.e., without physical contact with terrain or water). As such, aircraft 100 may be any type of airplane (regardless of size or propulsion means, ranging from large, turbine-powered commercial airplanes to small, electrically-powered drones), rotorcraft (helicopter, gyrocopter), lighter-than-air vessel (hot-air balloon, blimp), or glider, for example. Aircraft 100 may be “manned” in the conventional sense that the flight crew is present within the aircraft 100, or it may be manned remotely.

Processing system 105 functions to receive and process data from the various systems and databases of the aircraft 100 (e.g., systems 110-160 and database 170) during operation of the aircraft 100. The processing system 105 generally represents hardware, software, and/or firmware components configured to facilitate communications and/or interaction between the elements of the aircraft 100 and perform additional tasks and/or functions to support operation of the aircraft 100. Depending on the embodiment, the processing system 105 may be implemented or realized with a general-purpose processor, a content addressable memory, a digital signal processor, an application specific integrated circuit, a field programmable gate array, any suitable programmable logic device, discrete gate or transistor logic, processing core, discrete hardware components, or any combination thereof. The processing system 105 may also be implemented as a combination of computing devices, e.g., a plurality of processing cores, a combination of a digital signal processor and a microprocessor, a plurality of microprocessors, one or more microprocessors in conjunction with a digital signal processor core, or any other such configuration. In practice, the processing system 105 includes processing logic that may be configured to carry out the functions, techniques, and processing tasks associated with the operation of the aircraft 100, and in particular probabilistically determining the intended flight route of another aircraft. As such, processing system 105 may be embodied with data processing functionalities utilizing any custom made or commercially available processor, a central processing unit (CPU), a graphics processing unit (GPU), an auxiliary processor among several processors, a semiconductor-based microprocessor (in the form of a microchip or chip set), a macroprocessor, any combination thereof, or generally any device for executing electronic instructions. Moreover, processing system 105 may be embodied with data storage functionalities utilizing volatile and/or nonvolatile storage such as read-only memory (ROM), random-access memory (RAM), and keep-alive memory (KAM), for example, and may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data.

Flight management system 110 provides the primary navigation, flight planning, and route determination and en route guidance for the aircraft 100. Flight management system 110 may provide navigation data associated with the aircraft's current position and flight direction (e.g., heading, course, track, etc.) to processing system 105. The navigation data provided to processing system 105 may also include information about the aircraft's airspeed, ground speed, altitude (e.g., relative to sea level), pitch, and other important flight information if such information is desired. In any event, for this exemplary embodiment, flight management system 110 may include any suitable position and direction determination devices that are capable of providing processing system 105 with at least an aircraft's current position (e.g., in latitudinal and longitudinal form), the real-time direction (heading, course, track, etc.) of the aircraft in its flight path, and other important flight information (e.g., airspeed, altitude, pitch, attitude, etc.). Flight management system 110 and processing system 105 cooperate to guide and control aircraft 100 during all phases of operation, as well as to provide other systems of aircraft 100 (such as ADS-B system 130, for example) with flight data generated or derived from flight management system 110.

Position-determining system 120 is operably connected with the processing system 105 and cooperates with the operation of flight management system 110. Position-determining system 120 is configured to obtain one or more navigational parameters associated with the operation of the aircraft 100. The position-determining system 120 may be realized as one or more of a global positioning system (GPS), inertial reference system (IRS), or a radio-based navigation system (e.g., VHF omni-directional radio range (VOR) or long-range aid to navigation (LORAN)), and it may include one or more navigational radios or other sensors suitably configured to support operation of the aircraft 100. In some embodiments, the position-determining system 120 may also obtain and/or determine the heading of the aircraft 100 (i.e., the direction that aircraft 100 is traveling relative to some reference) using a magnet compass or a magnetometer, for example. The position-determining system 120 may also include a barometric altimeter such that the position of the aircraft 100 may be additionally determined with reference to a barometric altitude. In some embodiments, the GPS may alternatively or additionally provide altitude information as part of the position-determining system 120. As such, in an exemplary embodiment, the position-determining system 120 is capable of obtaining and/or determining the instantaneous position and altitude of the aircraft 100, that is, the current location of the aircraft 100 (e.g., the latitude and longitude) and the altitude and heading of the aircraft 100. The position-determining system 120 may provide this information to the processing system 105 and the flight management system 110 to support their operation, as described above.

ADS-B system 130 is operably connected with the processing system 105 and may receive information from and provide information to the flight management system 110 and the position-determining system 120. In some examples, ADS-B system 130 may be embodied within or as part of a transponder of the aircraft 100. ADS-B system 130 provides surveillance capabilities in which the aircraft 100 determines its position using position-determining system 120 and periodically broadcasts its position to cooperating ADS-B receivers, thereby enabling the aircraft to be tracked in real time or near-real time. The positional information may be received by air traffic control ground stations or by other aircraft with ADS-B receivers. ADS-B generated aircraft positional information from other aircraft in the vicinity of aircraft 100 may be received by the aircraft 100 to provide situational awareness to the flight crew of the aircraft 100. As used herein, the term “vicinity” means within the detectable range of ADS-B system 130. Moreover, the positional information from the other aircraft provides an input for the presently disclosed systems and methods for probabilistically determining the intended flight route of an aircraft in the vicinity of the aircraft 100, and as such the ADS-B system 130 provides this information to the processing system 105.

The flight-deck display system 140 may be embodied as an electronic display configured to graphically display flight information, traffic information, or other data associated with operation of the aircraft 100. In this regard, display system 140 is operably coupled to the processing system 105, and may receive and graphically display information from the flight management system 110 (such as the flight plan), position-determining system 120 (such as the position, altitude, and heading of aircraft 100), and the ADS-B system 130 (such as other aircraft in the vicinity of aircraft 100). The flight-deck display system 140 may be located within a flight-deck/cockpit of the aircraft 100. Flight-deck display system 140 may be embodied as one or more physical display devices of any type, and it may include a user interface that is adapted to allow a user (e.g., flight crew member) to interact with the display system 140 and more generally the FMS 110. Non-limiting examples of such display devices include various cathode ray tube (CRT) displays, and various flat panel displays such as various types of LCD (liquid crystal display) and TFT (thin film transistor) displays, panel mounted displays, and head-up display (HUD) projections. Non-limiting examples of such user interfaces include various keypads, touchpads, keyboards, mouses, touchscreens, joysticks, microphones, or other suitable devices adapted to receive input from a user. Flight-deck display system can also include other devices that are not physically integrated into the aircraft 100, such as an electronic flight bag (EFB) and the like. As will be described in greater detail below, the flight crew may interact with a graphical display of another aircraft in the vicinity using the display system 140 in order to obtain the probabilistic route information regarding that other aircraft. As such, in an exemplary embodiment, the user interface of the flight-deck display system 140 and processing system 105 are cooperatively configured to enable a user to indicate, select, or otherwise manipulate one or more items displayed on the flight-deck display system 140, for example to access intended flight route information associated with another aircraft.

Datalink system 150 is operably connected with the processing system 105 and may receive information from or provide information to the systems of aircraft 100. Datalink system 150 may be a satellite digital communication service provider or a ground-based digital communication service provider, for example, that may provide data communication, potentially including a broadband Internet connection, to the aircraft 100 in flight via satellites or ground stations. Datalink system 150 may enable data communication between the aircraft 100 and any server or data source located remotely from the aircraft 100. In some embodiments, the aircraft 100 may utilize the datalink system 150 to obtain any information relevant to the operation of the aircraft 100, such as route clearance information (which may be provided to the flight management system 110), weather information en route or at the departure or destination airport, and air traffic control instructions, for example. Moreover, the aircraft 100 may utilize the datalink system 150 to obtain publicly-available information regarding other aircraft in the vicinity of the aircraft 100, such as filed flight plan information, which may be utilized by processing system 105 as will be described in greater detail below for probabilistically determining an intended flight route of the other aircraft.

Weather radar system 160 is operably coupled with processing system 105 and flick-deck display system 140 to provide weather radar data to the flight crew of aircraft 100. In general, the weather radar system 160 may be any suitable radar system that is operable to detect weather that is located within a detectable range from the aircraft 100, such as 100 miles or more. The weather radar system 160 is configured to sense sufficient weather radar return information in order to determine a volume of water in a given three-dimensional region of airspace. Weather radar system 160 may include an antenna that is operable to emit radar pulses and to receive radar returns. The antenna may be operable sweep in a back-and-forth motion, and optionally in an up-and-down motion (tilt), such that the weather radar system 160 is able to scan an airspace region of interest in proximity to the aircraft. Such radar returns may be provided to processing system 105 for display on the flight-deck display system 140.

Navigation database 170 provides navigational data to the processing system 105 for use by the flight management system 110 and the flight-deck display system 140, in an embodiment. Navigation database 170 may include various types of navigation-related data stored therein. The navigation database 170 may be an onboard database that is carried by the aircraft 100. The navigation-related data may include various flight plan-related data such as, for example: waypoint location data for geographical waypoints; distances between waypoints; track between waypoints; terminal procedures; approach/departure procedures; airways; data related to different airports; navigational aids; obstructions; visual reporting points; special use airspace; political boundaries; and communication frequencies. The aircraft procedure information may be provided by or otherwise obtained from a governmental or regulatory organization, such as, for example, the Federal Aviation Administration in the United States. In an exemplary embodiment, the aircraft procedure information comprises instrument procedure information, such as instrument approach procedures, standard terminal arrival routes, instrument departure procedures, standard instrument departure routes, obstacle departure procedures, or the like, traditionally displayed on a published charts, such as Instrument Approach Procedure (IAP) charts, Standard Terminal Arrival (STAR) charts or Terminal Arrival Area (TAA) charts, Standard Instrument Departure (SID) routes, Departure Procedures (DP), terminal procedures, approach plates, and the like. Navigation database 170 may also include information regarding navigational reference points (e.g., waypoints, positional fixes, radio ground stations (VORs, VORTACs, TACANs, and the like), distance measuring equipment, non-directional beacons, etc.). Navigation database 170 may also include terrain information and information regarding the height and geographical location of obstacles. Any of the data in navigation database 170 may be provided to the flight management system 110 for using in determining or flying a particular route. This data may also be provided to the flight-deck display system 140 for purposes of displaying the navigation-related data to the flight crew in graphical form. Moreover, the processing system 105 may use the data from the navigation database 170 to generate a probabilistic determination of an intended flight route of another aircraft in the vicinity of aircraft 100, as will be discussed in greater detail below.

The systems and methods of the present disclosure operate using processing system 105 while aircraft 100 is in-flight. That is, aircraft 100 may be flying in accordance with a flight plan stored in flight management system 110 and displayed graphically on flight-deck display system 140 with reference to navigational waypoints as received from navigational database 170. Aircraft 100 may be obtaining positional information, such as geographic location, altitude, and heading from position-determining system 120, which may be displayed graphically on flight-deck display system 140. Aircraft 100 may also be receiving ADS-B Out transmissions at ADS-B system 130 from other aircraft in the vicinity, and these aircraft may be displayed graphically to the flight crew via display system 140. Depending on the atmospheric environment through which aircraft 100 is flying, it may also receive weather information (radar returns) from the weather radar system 160, which may be displayed graphically to the flight crew via display system 140. Still further, at various times throughout the flight, aircraft 100 may communicate information to or receive information from satellite or terrestrial data sources using the datalink system 150.

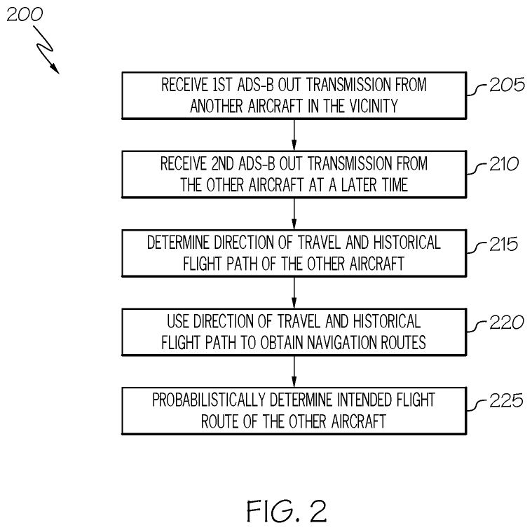

In the context of the foregoing in-flight scenario, and with continued reference to FIG. 1, FIG. 2 is a flowchart illustrating a method 200 for probabilistically determining the intended flight route of another aircraft in the vicinity of the aircraft 100 in accordance with an exemplary embodiment. Method 200 is illustrated showing a series of steps in a particular order; however, it should be appreciated that the steps may be performed in an alternative order, and more or fewer steps may be included in alternative embodiments. At step 205, at a first point in time, while the aircraft 100 is in flight as described above, ADS-B system 130 receives a first ADS-B Out transmission from another aircraft in the vicinity of aircraft 100. The first ADS-B Out transmission includes at least the identification, geographic position, and altitude of the other aircraft, but may also include its heading and groundspeed, among other information.

Thereafter, at step 210, at a second point in time that is temporally after the first point in time, the ADS-B system receives a second ADS-B out transmission from the other aircraft in the vicinity. This second ADS-B out transmission also includes the other aircraft's position, altitude, and optional other information. The second point in time may follow the first point in time by any time period ranging from the transmission interval of successive ADS-B Out transmissions to any number of seconds or minutes. Of course, the present disclosure is not limited to receiving just two ADS-B Out transmissions from the other aircraft; rather, any number of transmissions may be received and utilized, as described below.

At step 215 of method 200, the first and second (and optionally more) ADS-B Out transmissions from steps 205 and 210 are sent from the ADS-B system 130 to the processing system 105. At processing system 105, the ADS-B Out transmissions are used to compute a direction of travel and historical flight path of the other aircraft, and optionally other information such as the groundspeed of the other aircraft. The processing system 105 performs this computation using conventional principles of geometry and physics: each ADS-B out transmission represents a geographic “point” in space, which can be connected with a line segment that represents the historical flight path; the line segment has a length, which can be divided by the time interval between the transmissions to determine groundspeed; moreover, the line segment has an orientation with regard to spatial coordinates (magnetic bearing, for example) that can be used to determine direction of travel with reference to that coordinate system. Direction of travel and groundspeed can further be determined with supplemental reference to (i.e., verification of) the above-described optional information in the ADS-B Out transmissions, if provided.

Referring now to step 220 of method 200, the processing system 105 accesses the navigation database 170 to obtain any navigation routes that are in the area of the historical flight path of the other aircraft as determined at step 215. These navigation routes generally include any flight path or procedure that defines at least one segment between two geographic points. Examples of navigation routes include airways (both high and low altitude), oceanic routes, departure and arrival procedures, instrument and visual approaches, and obstacle procedures, among others. The processing system 105 may include logic for determining which routes to select and access. For example, the processing system 105 may only access navigation routes that include at least one point in space that is within a predetermined distance (such as any number of miles) from any point along the historical flight path of the other aircraft. Any navigation routes meeting the selection criteria are retained for further processing.

Furthermore, at step 225 of method 200, the processing system 105 uses the retained navigation routes from step 220 in comparison with the direction of travel and historical flight path of the other aircraft to probabilistically determine an intended flight route of the other aircraft. As used herein, the term “probabilistic intended flight route” refers to the particular navigation route of the retained navigation routes that the processing system 105 determines that the other aircraft is most likely following. As such, the “probabilistic intended flight route” is predictive in the sense that it provides the most likely flight route that the other aircraft will follow at times subsequent to the determination. The processing system 105 makes this probabilistic determination based on a number of factors, as described below.

One such factor may be the orientation of the flight path segment(s) of a retained navigation route under consideration as compared to the orientation of the historical flight path of the other aircraft. For example, one of the retained navigation routes may include a segment between two waypoints that is oriented east/west (i.e., a bearing of 90° or 270°). The orientation of the historical flight path of the other aircraft may be compared against the orientation of the navigation route to obtain a difference in orientation in terms of degrees, where a 0° difference (parallel) would be the highest probability for this factor and a difference of 90° (perpendicular) would be the lowest probability.

Another factor may be the distance of the flight path segment(s) of a retained navigation route under consideration as compared to the historical flight path of the other aircraft. For example, each point of the historical flight path could be compared against the closest point therefrom on one of the retained navigation routes to determine an average distance between the historical flight path and the navigation route. An average distance of 0 miles would be the highest probability for this factor whereas an average distance approaching the maximum distance according to the route selection criteria in step 220 would be the lowest probability.

Another factor may be the direction of travel of the other aircraft compared with the direction of travel of a retained navigation route under consideration, in the context of a navigation route that is intended to be traveled in only one direction, such as a departure or arrival procedure. The comparison for this factor would be similar to the orientation factor, except that a 180° difference between the direction of travel of the other aircraft and the direction of travel of the navigation route (i.e., indicating travel in the opposite direction) would be the lowest probability.

Another factor may incorporate the use of the weather radar system 160 of aircraft 100. For example, the weather radar system 160 may provide radar return data to the processing system 105 that indicates that a thunderstorm is located over a segment of one of the retained navigation routes under consideration. Of course, it should be appreciated that even if the other aircraft were “intending” to fly that navigation route in the sense that it was included the flight plan of the other aircraft, the other aircraft would likely deviate from the navigation route to avoid the thunderstorm. Thus, any navigation route wherein the weather radar system 160 indicates the presence of a thunderstorm may be provided with a probability compensation or adjustment to the aforementioned distance and orientation factors (i.e., a lateral offset from the navigation route of several miles could be expected when a thunderstorm is present, and a difference in orientation could be expected as the other aircraft turns to deviate from the navigation route before encountering the thunderstorm or turns to rejoin the navigation route after passing the thunderstorm). The amount of the compensation or adjustment (i.e., making that route more probable as the intended flight route of the other aircraft) may be determined on the basis of the size (lateral dimensions) of the observed thunderstorm, its distance from the current position of the other aircraft, and/or the location of the thunderstorm relative to the navigation route. Moreover, in the event that such a lateral offset from a retained navigation route under consideration is recognized, the processing system 105 may construct an artificial route (i.e., a route not found in navigation database 170) based on the amount of offset and the direction of travel of the other aircraft, which may rejoin one of the retained navigation routes under consideration at some future position or waypoint, and determine the same to be the intended flight route of the other aircraft.

Yet another factor may incorporate the use of the datalink system 150 of aircraft 100. As previously mentioned, some aircraft flight plans are publicly accessible. Flight plans include the navigation route(s) that an aircraft is proposing to fly from the departure airport to the arrival airport, and may include departure procedures, airways, and arrival procedures, for example. ADS-B Out transmissions may include the identifier (e.g., tail number or callsign) of the other aircraft. Accordingly, in an embodiment, the ADS-B system 130 may provide the other aircraft's callsign to the processing system 105, which may in turn make a request to the datalink system 150 to communicate with and access a remote data source that provides aircraft flight plans. If the flight plan for the other aircraft is available, the datalink system may provide this information to the processing system 105. Thereafter, processing system 105 may compare the filed flight plan of the other aircraft to any of the retained navigation routes under consideration from step 220. If there is a match between any navigation route included in the flight plan and any of the retained navigation routes, such matching route(s) may be provided with a probability adjustment (i.e., making that route more probable as the intended flight route of the other aircraft).

The foregoing recitation of factors that may be used by the processing system 105 to make a probabilistic determination of the intended flight route of the other aircraft should not be viewed as an exclusive list. Rather, other factors may be included in alternative embodiments. Moreover, each recited factor need not be included in any given determination. Furthermore, the relative importance of the recited factors need not be the same. For example, each of the factors could be provided with a “weighting” based on the relative importance of the particular factor to the probabilistic determination. The weightings may vary from embodiment to embodiment. As such, in accordance with the foregoing embodiments, step 225 of method 200 may be accomplished at the processing system 105 by determining a value of each factor as described above, optionally multiplying each such value by a weighting, and thereafter summing all of the values (or weighted values) to determine an overall probability. In an embodiment, the navigation route that has the highest overall probability (which may be the highest overall value or the lowest overall value, depending on how the factors are valued) is thus determined by the processing system 105 to be the probabilistic intended flight route of the other aircraft.

Of course, it is possible that none of the retained navigation routes under consideration are the intended flight route of the other aircraft. As such, in some embodiments, for a particular navigation route to be determined by the processing system 105 to be the probabilistic intended flight route of the other aircraft, a minimum threshold probability value may be required. In the event that a particular navigation route achieves at least this minimum probability value and is otherwise the most probable route of the retained navigation routes under consideration, then the processing system 105 determines that such route is the probabilistic intended flight route of the other aircraft. Conversely, if a particular navigation route achieves the highest overall probability but does not achieve the minimum threshold probability, then the system 105 does not associate a probabilistic intended flight route with the other aircraft. The minimum threshold probability value may vary from embodiment to embodiment.

Alternative embodiments of the present disclosure are also presently envisioned. For example, it should be appreciated that ADS-B Out transmissions are not the exclusive manner in which aircraft 100 could receive positional information regarding other aircraft in the vicinity, particularly where the other aircraft are not equipped with ADS-B Out capability. Rather, aircraft 100 could optionally be equipped with a traffic collision avoidance system (TCAS). TCAS is capable of interrogating the transponders of other aircraft and using the interrogation replies to determine bearing, distance, and altitude (for mode-C and mode-S capable transponders) of the other aircraft. Using this information in comparison to the current position of the TCAS-equipped aircraft, historical flight path information for the other aircraft can be constructed and used as described above in method 200 as an alternative to the information received directly from the ADS-B Out transmissions of the other aircraft. Alternatively or additionally, aircraft 100 could optionally be equipped with a traffic information service-broadcast (TIS-B) system. In this embodiment, air traffic control radar information is broadcast to aircraft 100 and received by its datalink system 150. The air traffic control radar information includes the geographic location and (if available) altitude of other aircraft in the vicinity of aircraft 100 that are observed by air traffic control radar. Here again, using this information, historical flight path information for the other aircraft can be constructed and used as described above in method 200 as an alternative to the information received directly from the ADS-B Out transmissions of the other aircraft.

The probabilistic intended flight route of the other aircraft as determined by the processing system 105 may be made available to the flight crew of the aircraft 100 using the above-described graphical display and user input functionalities of the flight-deck display system 140, for example. In an embodiment, the ADS-B system 130 provides information regarding the location of other aircraft in the vicinity to the flight-deck display system 140 for graphical display on a moving map or other form of display (optionally incorporating navigational information obtained from the navigation database 170 and/or flight route information of the aircraft 100 obtained from the flight management system 110 and/or weather radar returns from the weather radar system 160). The location of the other aircraft may be displayed using symbology indicative of heading, speed, and altitude of the other aircraft, as known in the art.

Based on this display, one or more of the other aircraft may be of interest to the flight crew for obtaining additional information about the intended flight route thereof, for example if a potential traffic conflict is perceived. The flight crew may use the user input functionality of the flight-deck display system 140 to indicate or otherwise “select” the one or more of the other aircraft. Upon such indication or selection, the probabilistic intended flight route of the other aircraft may be provided to the flight crew. The provision of this information may be accomplished in a graphical manner (for example, overlaying the probabilistic intended flight route on any display device of display system 140) or in a textual manner (for example, identifying the flight route or waypoints thereof textually on any display device of display system 140), or any combination thereof. Other means of providing this information, such as audibly or using symbology, are also contemplated herein.

Moreover, in various embodiments, all or any lesser portion of the probabilistic intended flight route may be made available to the flight crew in any of the manners described above. For example, some navigation routes, particularly airways, include many waypoints. Thus, the portion of the intended flight route of most interest to the flight crew may be the next (successive) waypoint that the other aircraft will reach. Accordingly, in some embodiments, the flight-deck display 140 may provide only the next waypoint, or the next several waypoints, while omitting depiction/description of the remainder of the intended flight route of the other aircraft. Optionally, if the groundspeed of the other aircraft is available, the processing system 105 may supplement the intended flight route of the other aircraft with an estimated time of arrival (ETA) of the other aircraft at the depicted/described waypoint(s), for example in a textual manner on the display system 140, so as to assist the flight crew in collision avoidance/situational awareness, particularly in scenarios where the same waypoint is included in the flight route of aircraft 100.

### ILLUSTRATIVE EXAMPLES

The present disclosure is now illustrated by the following non-limiting examples of flight-deck displays providing a probabilistic intended flight route of another aircraft in the vicinity of the ownship. It should be noted that various changes and modifications can be applied to the following examples without departing from the scope of this disclosure, which is defined in the appended claims. Therefore, it should be noted that the following examples should be interpreted as illustrative only and not limiting in any sense.

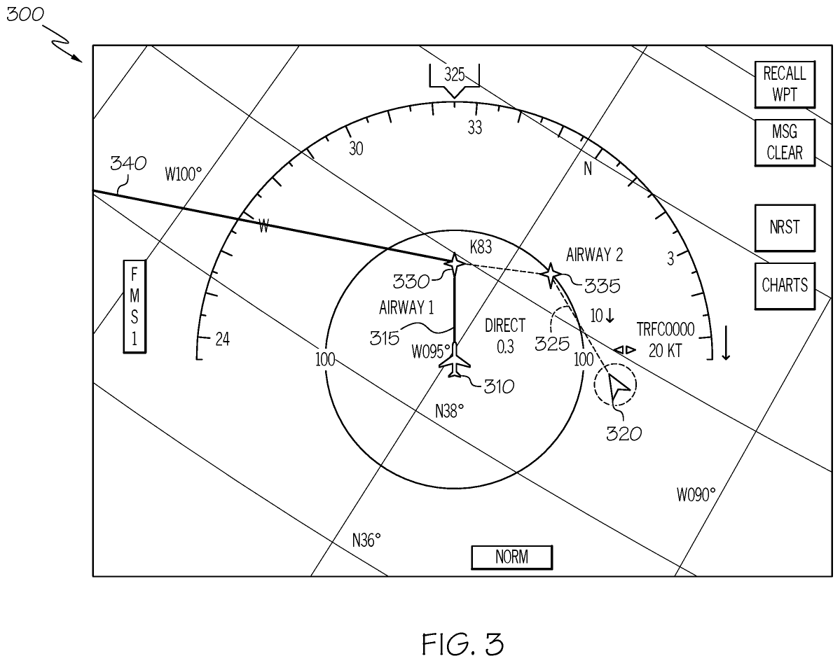

FIG. 3 illustrates an exemplary moving-map display 300 of flight-deck display system 140 in accordance with one embodiment of the present disclosure. Display 300 includes an ownship aircraft 310 and other aircraft 320 in the vicinity of the ownship aircraft 310. The flight route of the ownship aircraft 315 (“Airway 1”) is illustrated with a solid line, and it includes a depiction of the next waypoint along the ownship flight route 330 (“K63”). In this example, the flight crew of the ownship aircraft 310 has made an appropriate selection of the other aircraft 320 using the user input functionality of the flight-deck display system 140 such that the processing system 105 computes a probabilistic intended flight route of the other aircraft 325 (dashed line; “Airway 2”) and provides the display system 140 therewith. The probabilistic intended flight route of the other aircraft 325 includes a depiction of the next waypoint 335 thereof. As relevant to the ownship aircraft 310, flight routes 315 and 325 converge at waypoint 330, and as such both aircraft share a common route 340 after waypoint 330. It should be appreciated that a conventional display that included only the aircraft 310 and 320, and the flight route of the ownship aircraft 315, would give the appearance that the ownship aircraft 310 would turn at waypoint 330 in advance of converging with the other aircraft 320 based on its presently-depicted heading. Such a conventional display would give the flight crew of the ownship aircraft 310 the impression that there was no traffic conflict with the other aircraft 320. However, as illustrated, by including the probabilistic intended flight route of the other aircraft 325, it becomes apparent to the flight crew of the ownship aircraft 310 that a probably scenario is that both aircraft will reach waypoint 330 in the near future, and thereafter follow the same route. As such, the flight crew of the ownship aircraft 310 may monitor the other aircraft 320 more closely and/or take corrective action to avoid any possibility of a traffic conflict with the other aircraft 320.

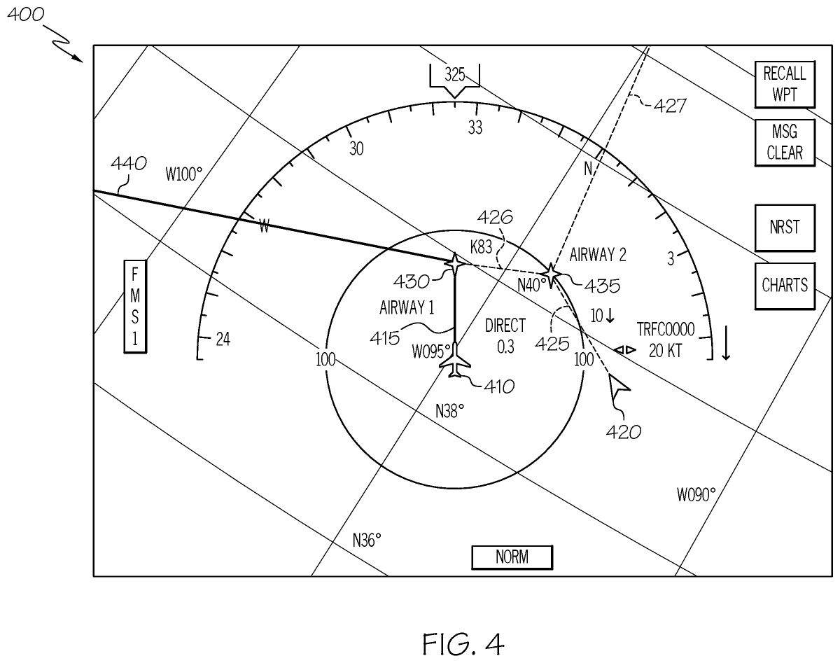

FIG. 4 illustrates an exemplary moving-map display 400 of flight-deck display system 140 in accordance with another embodiment of the present disclosure. Display 400 includes an ownship aircraft 410 and other aircraft 420 in the vicinity of the ownship aircraft 410. The flight route of the ownship aircraft 415 (“Airway 1”) is illustrated with a solid line, and it includes a depiction of the next waypoint along the ownship flight route 430 (“K63”). In this example, the flight crew of the ownship aircraft 410 has made an appropriate selection of the other aircraft 420 using the user input functionality of the flight-deck display system 140 such that the processing system 105 computes a probabilistic intended flight route of the other aircraft 425 (dashed line; “Airway 2”) and provides the display system 140 therewith. The probabilistic intended flight route of the other aircraft 425 includes a depiction of the next waypoint 435 thereof. In contrast with display 300, with regard to the flight route 425, after waypoint 435, there is a route divergence. That is, two different routes, first route 426 and second route 427, diverge from waypoint 435. Given the current position of the other aircraft 420, it is not possible to discern which of routes 426 or 427 will be followed. As such, display 400 includes a depiction of both routes 426, 427 such that the flight crew of the ownship aircraft 410 is apprised of the possibility of convergence at waypoint 430 and the possibility of the other aircraft 420 diverging after waypoint 435. The flight crew of the ownship aircraft 410 may thus monitor the other aircraft 420 and/or take any other action as it deems appropriate to the situation.

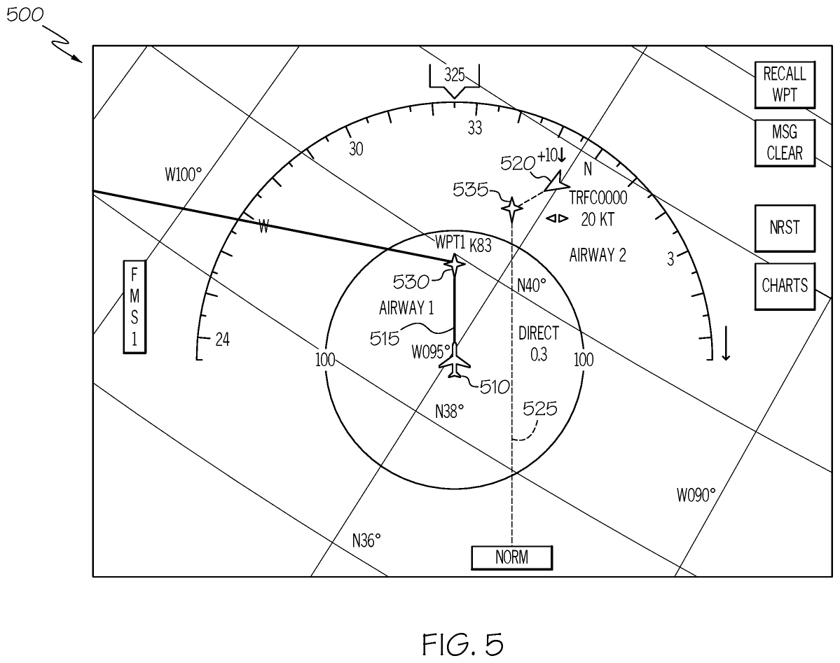

FIG. 5 illustrates an exemplary moving-map display 500 of flight-deck display system 140 in accordance with another embodiment of the present disclosure. Display 500 includes an ownship aircraft 510 and other aircraft 520 in the vicinity of the ownship aircraft 510. The flight route of the ownship aircraft 515 (“Airway 1”) is illustrated with a solid line, and it includes a depiction of the next waypoint along the ownship flight route 530 (“K63”). In this example, the flight crew of the ownship aircraft 510 has made an appropriate selection of the other aircraft 520 using the user input functionality of the flight-deck display system 140 such that the processing system 105 computes a probabilistic intended flight route of the other aircraft 525 (dashed line; “Airway 2”) and provides the display system 140 therewith. The probabilistic intended flight route of the other aircraft 525 includes a depiction of the next waypoint 535 thereof. As relevant to the ownship aircraft 510, flight routes 515 and 525 do not ever converge, and as such both aircraft should remain adequately separated from one another. It should be appreciated that a conventional display that included only the aircraft 510 and 520, and the flight route of the ownship aircraft 515, would give the appearance that the ownship aircraft 510 and the other aircraft 520 would converge in the vicinity of the waypoint 530 based on the presently-depicted heading of the other aircraft 520. Such a conventional display would give the flight crew of the ownship aircraft 510 the impression that there was a traffic conflict with the other aircraft 520, and they make take corrective action based on this impression. However, as illustrated, by including the probabilistic intended flight route of the other aircraft 525, it becomes apparent to the flight crew of the ownship aircraft 510 that a probably scenario is that the other aircraft 520 will diverge from the ownship aircraft 510 after waypoint 535. As such, the flight crew of the ownship aircraft 510 may avoid the need to take any corrective action.

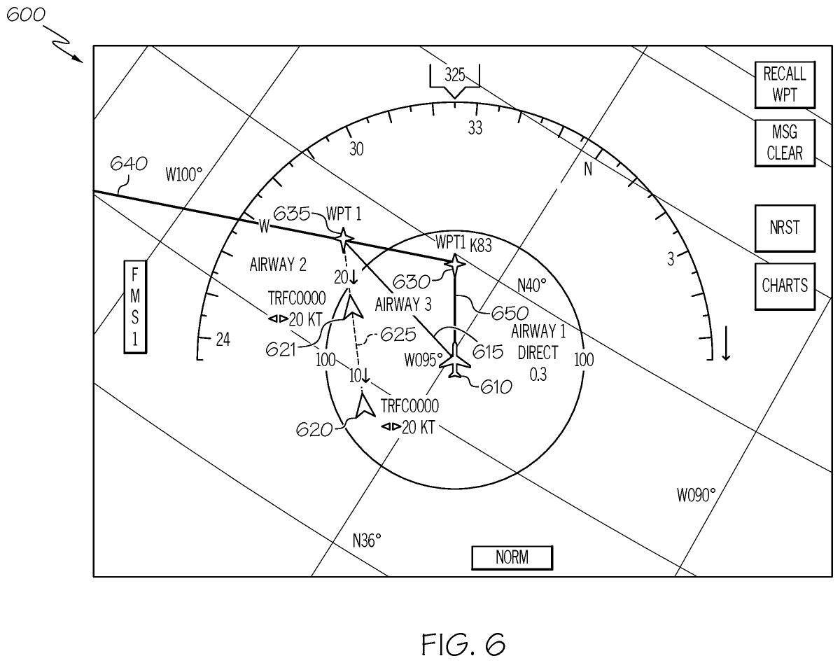

FIG. 6 illustrates an exemplary moving-map display 600 of flight-deck display system 140 in accordance with yet another embodiment of the present disclosure. Display 600 includes an ownship aircraft 610 and first and second other aircraft 620, 621 in the vicinity of the ownship aircraft 610. Different from the embodiments illustrated in the FIGS. 3-5 (i.e., displays 300, 400, and 500), the display 600 includes a weather radar return 650 from a thunderstorm in the vicinity of the ownship aircraft 610, and as such additionally utilizes information provided from weather radar system 160. The flight route of the ownship aircraft 615 is illustrated with a solid line, and in this display represents a deviation from illustrated “Airway 1” in order to avoid the thunderstorm, which is located directly over airway 1 in advance of waypoint 630 (“K63”). As such, the ownship aircraft 610 is deviating directly to the subsequent waypoint 635 (“WPT 1”) to avoid the thunderstorm. Furthermore, in this example, the flight crew of the ownship aircraft 610 has made appropriate selections of the other aircraft 620, 621 using the user input functionality of the flight-deck display system 140 such that the processing system 105 computes a probabilistic intended flight route of the other aircraft 625 and provides the display system 140 therewith. In this scenario, due to the thunderstorm, the processing system 105 recognizes an offset from Airway 1 as the most probable “route” that will be flown by other aircraft 620, 621 (i.e., route 625 is not a conventional “route” available in navigation database 170, but it is a recognized offset from Airway 1, due to the thunderstorm, which rejoins an airway at waypoint 635). As such, utilizing this recognized offset in conjunction with the current heading of aircraft 620 and 621, route 625 is illustrated as the actual most probably path that the aircraft 620 and 621 will fly, and waypoint 635 is illustrated as the next probable waypoint that other aircraft 620 and 621 will reach, as opposed to waypoint 630 along Airway 1. As relevant to the ownship aircraft 610, flight routes 615 and 625 converge at waypoint 635, and as such both aircraft share a common route 640 (“Airway 2”) after waypoint 635. Thus, utilizing this information that has accounted for the presence of the weather radar return 650, the flight crew of the ownship aircraft 610 may monitor the other aircraft 620, 621 more closely and/or take corrective action to avoid any possibility of a traffic conflict with the other aircraft 620, 621.

Accordingly, the present disclosure has provided several embodiments of systems and methods for probabilistically determining the intended flight route of an aircraft in the vicinity of the ownship. The disclosed systems and methods beneficially provide the ownship flight crew with improved situational awareness regarding potential traffic conflicts. This improved situational awareness advantageously includes an independent, probabilistic determination of the intended flight route of the other aircraft such that the flight crew may anticipate future traffic conflicts that would not be immediately apparent from the real-time position, altitude, and velocity information received via ADS-B In (or any other known air traffic surveillance system), as described in detail above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method executable at an ownship aircraft for probabilistically determining an intended flight route of an other aircraft in the vicinity of the ownship aircraft, the method comprising:
receiving, in an air traffic surveillance system, first positional information regarding the other aircraft at a first point in time;
receiving, in the air traffic surveillance system, second positional information regarding the other aircraft at a second point in time that is temporally subsequent to the first point in time;
determining, in a processing system, a historical flight path of the other aircraft based on the first and second positional information;
comparing, in the processing system, the historical flight path of the other aircraft to a plurality of navigation routes; and
based on the comparing, probabilistically determining, in the processing system, one navigation route of the plurality of navigation routes as the intended flight route of the other aircraft.

2. The method of claim 1, wherein the first and second positional information regarding the other aircraft is received using an air traffic surveillance system of the ownship aircraft that is selected from the group consisting of: an automatic dependent surveillance-broadcast (ADS-B) system, a traffic collision avoidance system (TCAS), and a traffic information service-broadcast (TIS-B) system, and combinations of two or more thereof.

3. The method of claim 1, wherein the first positional information comprises a first geographic point and the second positional information comprises a second geographic point, and wherein the historical flight path comprises a flight path segment beginning at the first geographic point and ending at the second geographic point.

4. The method of claim 1, further comprising receiving third positional information regarding the other aircraft at a third point in time that is temporally subsequent to the second point in time, and further comprising determining the historical flight path of the other aircraft based on the first, second, and third positional information.

5. The method of claim 1, wherein each navigation route of the plurality of navigation routes is independently selected from the group consisting of: an airway, an oceanic route, a departure procedure, an arrival procedure, an instrument approach procedure, a visual approach procedure, and an obstacle procedure.

6. The method of claim 1, wherein the comparing comprises determining a degree of difference between an orientation of the historical flight path and an orientation of each navigation route of the plurality of navigation routes.

7. The method of claim 1, wherein the comparing comprises determining an average distance between the historical flight path and each navigation route of the plurality of navigation routes.

8. The method of claim 1, further comprising receiving a direction of travel of the other aircraft, and wherein the comparing comprises determining a degree of difference between the direction of travel of the other aircraft and a direction of travel of each navigation route of the plurality of navigation routes.

9. The method of claim 1, further comprising receiving weather radar information, and wherein the probabilistically determining comprises establishing a lateral offset from each navigation route of the plurality of navigation routes based on the weather radar information.

10. The method of claim 1, further comprising receiving flight plan information regarding the other aircraft, wherein probabilistically determining comprises referencing the flight plan information against each navigation route of the plurality of navigation routes.

11. The method of claim 1, further comprising displaying the intended flight route of the other aircraft at the ownship aircraft.

12. A system executable at an ownship aircraft for probabilistically determining an intended flight route of an other aircraft in the vicinity of the ownship aircraft, the system comprising:
an air traffic surveillance system that (1) receives first positional information regarding the other aircraft at a first point in time and (2) receives second positional information regarding the other aircraft at a second point in time that is temporally subsequent to the first point in time; and
a processing system in operable communication with the air traffic surveillance system, the processing system configured to (3) determine a historical flight path of the other aircraft based on the first and second positional information, (4) compare the historical flight path of the other aircraft to a plurality of navigation routes, and (5) based on the comparing, probabilistically determine one navigation route of the plurality of navigation routes as the intended flight route of the other aircraft.

13. The system of claim 12, wherein the air traffic surveillance system is selected from the group consisting of: an automatic dependent surveillance-broadcast (ADS-B) system, a traffic collision avoidance system (TCAS), and a traffic information service-broadcast (TIS-B) system, and combinations of two or more thereof.

14. The system of claim 12, wherein the first positional information comprises a first geographic point and the second positional information comprises a second geographic point, and wherein the historical flight path comprises a flight path segment beginning at the first geographic point and ending at the second geographic point.

15. The system of claim 12, wherein the processing system (4) compares by determining a degree of difference between an orientation of the historical flight path and an orientation of each navigation route of the plurality of navigation routes.

16. The system of claim 12, wherein the processing system (4) compares by determining an average distance between the historical flight path and each navigation route of the plurality of navigation routes.

17. The system of claim 12, further comprising a weather radar system that receives weather radar information, and wherein the processing system (5) probabilistically determines by establishing a lateral offset from each navigation route of the plurality of navigation routes based on the weather radar information.

18. The system of claim 12, further comprising a datalink system that receives flight plan information regarding the other aircraft, and wherein the processing system (5) probabilistically determines by referencing the flight plan information against each navigation route of the plurality of navigation routes.

19. The system of claim 12, further comprising a flight-deck display system that displays the intended flight route of the other aircraft.

20. An aircraft comprising the system of claim 12.
